(19) United States
(12) Patent Application Publication
(10) Pub. No.: US 2012/0276948 A1
(43) Pub. Date: Nov. 1, 2012

(54) ELECTRONIC DEVICE AND METHOD FOR SWITCHING TO VOICE MODE

(75) Inventors: XIANG CAO, Shenzhen City (CN); HAI-QING ZHOU, Shenzhen City (CN)

(73) Assignees: HON HAI PRECISION INDUSTRY CO., LTD., Tu-Cheng (TW); HONG FU JIN PRECISION INDUSTRY(ShenZhen) CO., LTD ., Shenzhen City (CN)

(21) Appl. No.: 13/452,959

(22) Filed: Apr. 23, 2012

(30) Foreign Application Priority Data
Apr. 27, 2011 (CN) 201110106687.3

(51) Int. Cl. H04W 88/02

(52) U.S. Cl. 455/551

(57) ABSTRACT

In a method of switching to a voice mode, an electronic device controls a speaker of the electronic device to play a first audio recording when a mode button of the electronic device is pressed a first time. The electronic device dials a telephone number consisted of received numbers when the mode button is pressed a second time and controls to the speaker to play a second audio recording corresponding to the telephone number.

### BACKGROUND

1. Technical Field

Embodiments of the present disclosure relate to electronic device control methods, and more particularly to an electronic device and a method for switching to a voice mode.

2. Description of Related Art

An electronic device (e.g., a mobile phone) may be a pocket-sized computing device, which has a small visual display for output and a miniature keyboard or touch screen for input. However, for people who have poor or no eyesight, such as old people or blind people, it may not be easy for them to dial a telephone number, for example, they may not be sure of the number which he/she is dialing. What is needed, therefore, is an electronic device and a method to overcome aforementioned problems.

### BRIEF DESCRIPTION OF THE DRAWINGS

FIG. 1 is a block diagram of one embodiment of an electronic device.

FIG. 2 illustrates one embodiment of a keypad area as disclosed, utilizing the electronic device of FIG. 1.

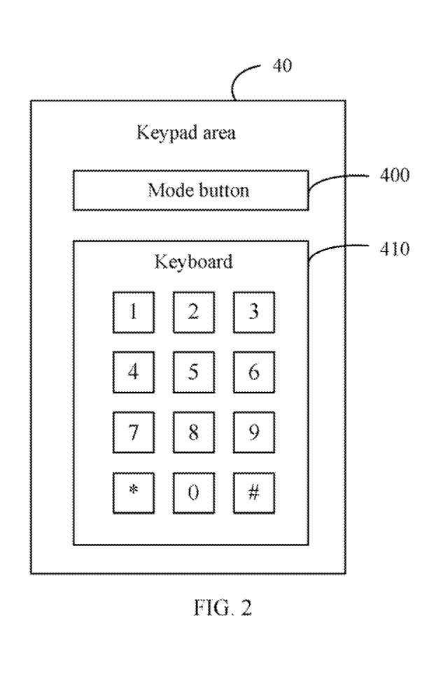

FIG. 3 is a flowchart of one embodiment of a method for switching to a voice mode.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-playable medium or other storage device. Some non-limiting examples of non-transitory computer-playable media include CDs, DVDs, BLU-RAY, flash memory, and hard disk drives.

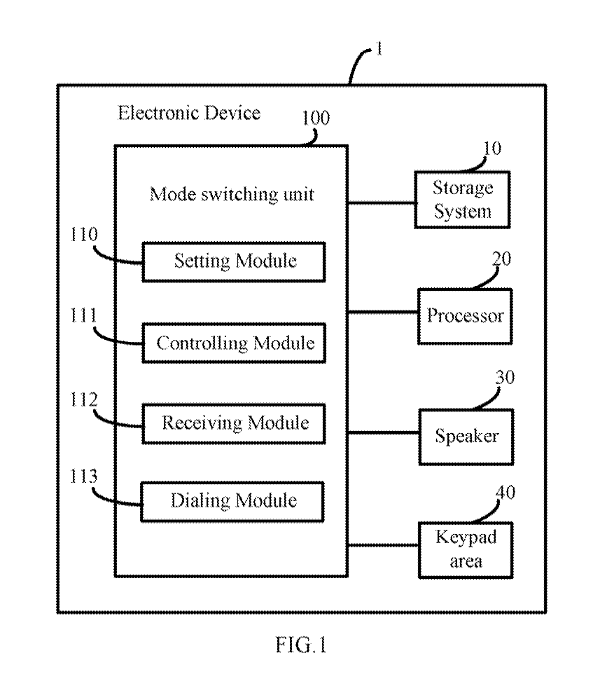

FIG. 1 is a block diagram of one embodiment of an electronic device 1. The electronic device 1 includes a storage system 10, at least one processor 20, a speaker 30 and a keypad area 40. The storage system 10 stores a first audio recording and a second audio recording. For example, content of the first audio recording may be “You have entered into a voice mode, please input your telephone number!.” The content of the second audio recording may be “The telephone number you dial is ‘xxxxxx,’ the electronic device is connecting to the telephone number, please wait!”. The storage system 10 may be a memory, such as an EPROM, HDD, a hard disk drive, or a cache. The processor 20 may be a CPU. The speaker 30 is used to audibly play the first audio recording and the second audio recording. The speaker 30 plays the first audio recording when the electronic device 1 enters the voice mode. The speaker 30 plays the second audio recording when the electronic device 1 dials a telephone number. In one embodiment, as shown in FIG. 4, the keypad area 40 includes a mode button 400 and a keyboard 410. When a user presses the mode button 400, the electronic device 1 enters the voice mode. For example, if the electronic device 1 enters the voice mode, the user can hear an audible announcement of a number when he/she presses a number key on the keyboard 410. The mode button 400 may be a physical button and is conspicuous and easily found by the user. For example, the mode button 400 may be designed to be two times bigger than the other keys in the keyboard 410. The keyboard 400 is used to dial telephone numbers. The keyboard 400 may be a physical keyboard or a virtual keyboard. Depending on the embodiment, the electronic device 1 may be a mobile phone, a personal digital assistant (PDA), a handheld game console, a tablet computer, or other device.

The electronic device 1 is generally controlled and coordinated by an operating system, such as UNIX, LINUX, WINDOWS, MAC OS X, an embedded operating system, or any other compatible operating systems. In other embodiments, the electronic device 1 may be controlled by a proprietary operating system. All such operating systems control and schedule computer processes for execution, perform memory management, provide a file system, networking, and I/O services, and provide a user interface, such as a graphical user interface (GUI), among other things.

The electronic device 1 further includes a mode switching unit 100. The mode switching unit 100 is used to switch the electronic device 1 to the voice mode and dial the telephone number under the voice mode. In one embodiment, the mode switching unit 100 includes a setting module 110, a controlling module 111, a receiving module 112, and a dialing module 113. The modules 110-113 may include computerized code in the form of one or more programs that are stored in the storage system 10. The computerized code includes instructions that are executed by the at least one processor 20 to provide functions for modules 110-113.

The setting module 110 sets parameters for the voice mode in the electronic device 1. In one embodiment, the parameters include a number of repetitions (e.g., three) that are used to play the first audio recording and the second audio recording, and a volume level (e.g., twenty decibels) that is used to play the first audio recording and the second audio recording.

The controlling module 111 controls the speaker 30 to play the first audio recording when the user presses the mode button 400 a first time. For example, the speaker 30 plays the first audio recording on twenty decibels three times. The user is notified that the electronic device 1 enters the voice mode when the speaker 30 plays the first audio recording.

The receiving module 112 receives a number corresponding to a number key of the keyboard 410 when the user presses the number key on the keyboard 410. For example, if the user presses the number key “5,” the receiving module 112 receives the number “5” from the keyboard 410.

The controlling module 111 controls the speaker 30 to play an audible announcement of the received number. The user can know what key he/she presses when the user hears the audible announcement of the received number played by the speaker 30.

The dialing module 113 dials a telephone number consisting of the received numbers when the user presses the mode button 400 a second time, and controls the speaker 30 to play the second audio recording corresponding to the telephone number. In one embodiment, the dialing module inserts the telephone number into the second audio recording, then the speaker 30 can play the second audio recording including the telephone number. The content of the seconding recording changes according to the telephone number. For example, if the telephone number is “123456,” and the speaker 30 announces “The telephone number you dialed is ‘123456,’ the electronic device is connecting to the telephone number, please wait!” If the telephone number is “987654,” the speaker 30 announces “The telephone number you dialed is ‘987654,’ the electronic device is connecting to the telephone number, please wait!”

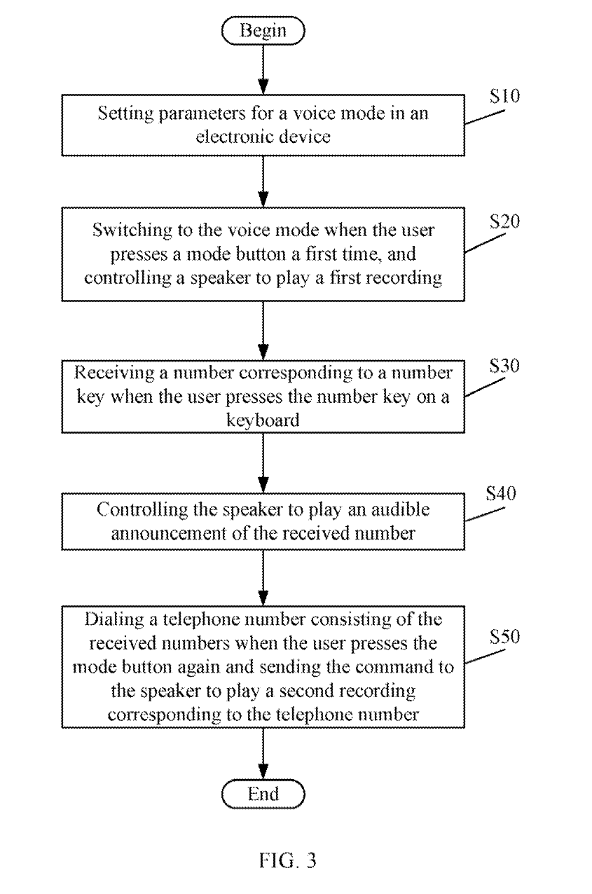

FIG. 3 is a flowchart of one embodiment of a method for switching to a voice mode using an electronic device 1. Depending on the embodiment, additional blocks may be added, others deleted, and the ordering of the blocks may be changed.

In block S10, the setting module 110 sets parameters for a voice mode in the electronic device 1. As mentioned above, the parameters include a number of repetitions (e.g., three) that are used to play the first audio recording and the second audio recording, and a volume level (e.g., twenty decibels) that is used to play the first audio recording and the second audio recording.

In block S20, the controlling module 111 controls the speaker 30 to play the first audio recording when the user presses a mode button 400 a first time. For example, if the first audio recording is played by the speaker 30, it is audibly indicated that the electronic device 1 has entered a voice mode when the speaker 30 plays the first audio recording.

In block S30, the receiving module 112 receives a number corresponding to a number key of the keyboard 410 when the user presses the number key on the keyboard 410. For example, if the user presses number key “5,” the receiving module 112 receives the number “5” from the keyboard 410.

In block S40, the controlling module 111 controls the speaker 30 to play an audible announcement of the received number. For example, the speaker 30 announces the number “5” on a volume level of twenty decibels, three times.

In block S50, dialing module 113 dials a telephone number consisting of the received numbers when the user presses the mode button 400 a second time, and controls the speaker to play the second audio recording corresponding to the telephone number. For example, if the user presses number key “1,” key “2,” key “3,” key “4,” key “5,” and key “6,” the telephone number is consisted of “123456”. The dialing module 113 dials the telephone number “123456” when the user presses the mode button 400 a second time. The speaker 30 announces “The telephone number you dialed is “123456,” the electronic device is connecting to the telephone number, please wait!” In one embodiment, the dialing module 113 inserts the telephone number into the second audio recording, then the speaker 30 can play the second audio recording including the telephone number. For example, if the telephone number is “123456,” the dialing module inserts the telephone number “123456” into the second audio recording. If the telephone is “987654,” the dialing module 113 inserts the telephone number “987654” into the second audio recording.

Although embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a storage system storing a first audio recording and a second audio recording;
at least one processor; and
one or more programs stored in the storage system and being executable by the at least one processor, the one or more programs comprising:
a controlling module that controls a speaker of the electronic device to play the first audio recording when a mode button of the electronic device is pressed a first time by a user;
a receiving module that receives one or more numbers corresponding to number keys of a keyboard of the electronic device when the user presses the number keys on the keyboard of the electronic device;
the controlling module further controls the speaker to play an audible announcement of each of the one or more received numbers; and
a dialing module that dials a telephone number consisting of the one or more received numbers when the mode button is pressed a second time by the user, and controls the speaker to play the second audio recording corresponding to the telephone number.

2. The electronic device of claim 1, the one or more programs further comprising:
a setting module that sets parameters for a voice mode in the electronic device, the electronic device enters the voice mode when the mode button is pressed by the user and the speaker plays the first audio recording.

3. The electronic device of claim 2, wherein the parameters comprises a number of repetitions of the first audio recording and the second audio recording, and a volume level of the first audio recording and the second audio recording.

4. The electronic device of claim 1, wherein the dialing module further inserts the telephone number into the second audio recording when the speaker plays the second audio recording.

5. The electronic device of claim 1, wherein the electronic device is selected from the group consisting of a mobile phone, a tablet computer, a personal digital assistant, and a handheld game console.

6. A method for switching to a voice mode using an electronic device, the method comprising:
controlling a speaker of the electronic device to play a first audio recording when a mode button of the electronic device is pressed a first time by a user;
receiving one or more numbers corresponding to number keys of a keyboard of the electronic device when the user presses the number keys on the keyboard of the electronic device;
controlling the speaker to play an audible announcement of each of the one or more received numbers; and
dialing a telephone number consisting of the one or more received numbers when the mode button is pressed a second time by the user, and controlling the speaker to play the second audio recording corresponding to the telephone number.

7. The method of claim 6, further comprising:
setting parameters for the voice mode in the electronic device, the electronic device enters the voice mode when the mode button is pressed by the user and the speaker plays the first audio recording.

8. The method of claim 7, wherein the parameters comprises a number of repetitions of the first audio recording and the second audio recording, and a volume level of the first audio recording and the second audio recording.

9. The method of claim 6, wherein the telephone number is inserted into the second audio recording when the speaker plays the second audio recording.

10. The method of claim 6, wherein the electronic device is selected from the group consisting of a mobile phone, a tablet computer, a personal digital assistant, and a handheld game console.

11. A non-transitory computer-playable medium having stored thereon instructions that, when executed by an electronic device, causes the electronic device to perform a method for switching to a voice mode, the method comprising:
controlling a speaker of the electronic device to play a first audio recording when a mode button of the electronic device is pressed a first time by a user;
receiving one or more numbers corresponding to number keys of a keyboard of the electronic device when the user presses the number keys on the keyboard of the electronic device;
controlling the speaker to play an audible announcement of each of the one or more received numbers; and
dialing a telephone number consisting of the one or more received numbers when the mode button is pressed a second time by the user, and controlling the speaker to play the second audio recording corresponding to the telephone number.

12. The medium of claim 11, wherein the method further comprising:
setting parameters for the voice mode in the electronic device, the electronic device enters the voice mode when the mode button is pressed by the user and the speaker plays the first audio recording

13. The medium of claim 12, wherein the parameters comprises a number of repetitions of the first audio recording and the second audio recording, and a volume level of the first audio recording and the second audio recording.

14. The medium of claim 11, wherein the telephone number is inserted into the second audio recording when the speaker plays the second audio recording.

15. The medium of claim 11, wherein the electronic device is selected from the group consisting of a mobile phone, a tablet computer, a personal digital assistant, and a handheld game console.
